(19) United States
(12) Patent Application Publication
(10) Pub. No.: US 2007/0100070 A1
(43) Pub. Date: May 3, 2007

(54) Poly(arylene ether) blend and method of making same

(76) Inventors: Michael L. Todt, Rexford, NY (US); Geoffrey H. Riding, Castleton, NY (US)

Correspondence Address: CANTOR COLBURN, LLP, 55 GRIFFIN ROAD SOUTH, BLOOMFIELD, CT, 06002, US

(21) Appl. No.: 11/265,681

(22) Filed: Nov. 2, 2005

(51) Int. Cl. C08L 51/08

(52) U.S. Cl. 525/63

(57) ABSTRACT

A resin composition includes a poly(arylene ether), a poly(alkenyl aromatic) having a melt index of about 10 to about 250 grams/minute as measured by ASTM D 1238, Procedure B at 200 ° C. and 5 kilogram load, and a rubber-modified poly(alkenyl aromatic). The composition exhibits improved flow in extrusion and molding operations.

### BACKGROUND OF THE INVENTION

This disclosure relates to poly(arylene ether) compositions, and more particularly to high flow poly(arylene ether) compositions.

Poly(arylene ether) resins, such as polyphenylene ether (PPE) resins, are an extremely useful class of high performance engineering thermoplastics by reason of their hydrolytic stability, high dimensional stability, toughness, heat resistance, and dielectric properties. This unique combination of properties renders poly(arylene ether) based compositions suitable for a broad range of applications, which are well known in the art. For example, poly(arylene ether) blends are being widely used in the fields of automobile parts, electric parts, office devices, and the like.

One area in which poly(arylene ether) compositions have required an improvement is melt flow capability, i.e., the ability to flow freely at elevated temperatures during various processing stages such as extrusion and molding. Poor melt flow can impact the size and type of parts that can be prepared with the composition.

Accordingly, a continual need exists in the art for improvements in the flow capability of poly(arylene ether) compositions.

### BRIEF DESCRIPTION OF THE INVENTION

The needs discussed above have been satisfied by a resin composition comprising a poly(arylene ether); a poly(alkenyl aromatic) having a melt index of about 10 to about 250 grams/minute as measured by ASTM D 1238, Procedure B at 200 ° C. and 5 kilogram load; and a rubber-modified poly(alkenyl aromatic).

A method for preparing the compositions is also provided.

### DETAILED DESCRIPTION OF THE INVENTION

In this specification and in the claims, which follow, reference will be made to a number of terms which shall be defined to have the following meanings.

The singular forms “a,” “an,” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

Furthermore, the endpoints of all ranges reciting the same characteristic are independently combinable and inclusive of the recited endpoint.

As will be explained in greater detail below, it has unexpectedly been discovered that a blend comprising: a) poly(arylene ether); b) a high flow poly(alkenyl aromatic); and c) a rubber-modified poly(alkenyl aromatic), has an increased melt flow compared to a blend comprising only a poly(arylene ether) and a rubber-modified poly(alkenyl aromatic).

The poly(arylene ether) blend has a melt index of greater than or equal to about 20 grams per minute, specifically greater than or equal to 25 grams per minute, even more specifically greater than or equal to 30, wherein the melt index is measured by American Society for Testing Materials (“ASTM”) D 1238, Procedure B at 280° C. and 5 kilogram load. Moreover, in one embodiment, the poly(arylene ether) blend comprises a melt index of 20 grams per minute to 200 grams per minute, more specifically 25 grams per minute to 100 grams per minute.

As used herein, a “poly(arylene ether)” comprises a plurality of structural units of the formula (I): 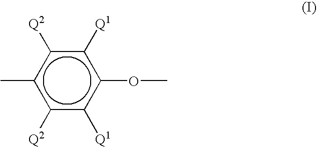
wherein for each structural unit, each Q¹ is independently halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, aryl and halohydrocarbonoxy, wherein at least two carbon atoms separate the halogen and oxygen atoms; and each Q² is independently hydrogen, halogen, primary or secondary lower alkyl (e.g., an alkyl containing 1 to about 7 carbon atoms), phenyl, haloalkyl, aminoalkyl, alkenylalkyl, alkynylalkyl, hydrocarbonoxy, aryl and halohydrocarbonoxy, wherein at least two carbon atoms separate the halogen and oxygen atoms. In some embodiments, each Q¹ is independently C₁-C₄ alkyl or phenyl, and each Q² is independently hydrogen or methyl. The poly(arylene ether) can comprise molecules having aminoalkyl-containing end group(s), typically located in an ortho position to the hydroxy group. Also frequently present are tetramethyl diphenoquinone (TMDQ) end groups, typically obtained from reaction mixtures in which tetramethyl diphenoquinone by-product is present.

The poly(arylene ether) can be in the form of a homopolymer; a copolymer; a graft copolymer; an ionomer; or a block copolymer; as well as combinations comprising at least one of the foregoing. For example, in one embodiment, poly(arylene ether) includes polyphenylene ether (PPE) containing 2,6-dimethyl-1,4-phenylene ether units optionally in combination with 2,3,6-trimethyl-1,4-phenylene ether units.

The poly(arylene ether) can be prepared by the oxidative coupling of monohydroxyaromatic compound(s) such as 2,6-xylenol and 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, N,N′-dialkylalkylenediamine, halide or combinations of two or more of the foregoing.

The poly(arylene ether) can be functionalized with a polyfunctional compound such as a polycarboxylic acid or those compounds having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid, maleic anhydride, fumaric acid, and citric acid.

The poly(arylene ether) can have a number average molecular weight of about 3,000 grams per mole (g/mol) to about 40,000 g/mol and a weight average molecular weight of about 5,000 g/mol to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) or combination of poly(arylene ether)s has an initial intrinsic viscosity of 0.3 deciliters per gram (dl/g) to 0.6 deciliters per gram (dl/g), as measured in chloroform at 25° C. Initial intrinsic viscosity is defined as the intrinsic viscosity of the poly(arylene ether) prior to melt mixing with the other components of the composition. As understood by one of ordinary skill in the art, the viscosity of the poly(arylene ether) can be up to 30% higher after melt mixing. The percentage of increase can be calculated by (final intrinsic viscosity—initial intrinsic viscosity)/initial intrinsic viscosity. Determining an exact ratio, when two initial intrinsic viscosities are used, will depend somewhat on the exact intrinsic viscosities of the poly(arylene ether) used and the ultimate physical properties that are desired.

The poly(arylene ether) is generally used in amounts of 10 weight percent (wt. %) to 99.5 wt. %. Within this range, the poly(arylene ether) can be used in amounts greater than or equal to 20 wt. %, and more specifically greater than or equal to 30 wt. %. Also within this range, the poly(arylene ether) can be used in amounts of less than or equal to 85 wt. %, and more specifically less than or equal to 80 wt. %. Weight percent are based on a total weight of the composition

The composition further comprises a high flow poly(alkenyl aromatic). The term high flow in relation to the poly(alkenyl aromatic) component refers to a poly(alkenyl aromatic) comprising a melt index of about 10 grams per minute (“g/min”) to 250 grams per minute, wherein the melt index is measured by ASTM D 1238, Procedure B at 200° C. and 5 kilogram load. In one embodiment, the melt index is greater than or equal to 20 grams per minute, and even more specifically the melt index is greater than or equal to 30 grams per minute.

Specifically, the composition comprises a homopolymer of an alkenyl aromatic monomer, wherein the alkenyl aromatic monomer has the formula (II): 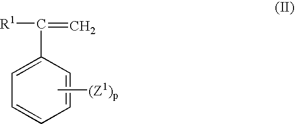
wherein R¹ is hydrogen, lower alkyl or halogen; Z¹ is vinyl, halogen or lower alkyl; and p is from 0, 1, 2, 3, 4, or 5. Specific alkenyl aromatic monomers include styrene, chlorostyrene, and vinyltoluene. A more specific homopolymer of an alkenyl aromatic monomer is the homopolymer derived from styrene (i.e., homopolystyrene). In one embodiment, the homopolystyrene comprises at least 99% of its weight, specifically 100% of its weight, from styrene.

The composition may comprise the homopolymer of an alkenyl aromatic monomer in an amount of about 5 wt. % to about 20 wt. %, specifically about 7.5 wt. % to about 16 wt. %, based on the total weight of the composition.

In one embodiment, the high flow poly(alkenyl aromatic) is substantially free of mineral oil. By substantially free, it is meant that the high flow poly(alkenyl aromatic) comprises less than about 0.1 wt. % mineral oil based on a total weight of the high flow poly(alkenyl aromatic). In this embodiment, the high flow poly(alkenyl aromatic) specifically comprises no intentionally added mineral oil.

In one embodiment, the high flow poly(alkenyl aromatic) comprises a high flow General Purpose Polystyrene (GPPS). While high flow GPPS is not commonly available as a virgin material, it is readily available as recycled expanded polystyrene (EPS) packaging materials.

The high flow poly(alkenyl aromatic) is generally used in amounts of about 5 wt. % to about 20 wt. %. Within this range, the high flow poly(alkenyl aromatic) can be greater than or equal to about 7.5 wt. %, and more specifically greater than or equal to about 8.5 wt. %. Also within this range, the high flow poly(alkenyl aromatic) can be less than or equal to about 16.5 wt. %, and more specifically less than or equal to about 15 wt. %. Weight percents are based on a total weight of the composition.

The composition further comprises a rubber-modified poly(alkenyl aromatic) resin. A rubber-modified poly(alkenyl aromatic) resin comprises a polymer derived from at least one of the alkenyl aromatic monomers described above, and further comprises a rubber modifier in the form of a blend and/or a graft. The rubber modifier may be a polymerization product of at least one C₄-C₁₀ nonaromatic diene monomer, such as butadiene or isoprene. The rubber-modified poly(alkenyl aromatic) resin comprises about 98 wt. % to about 70 wt. % of the poly(alkenyl aromatic) resin and about 2 wt. % to about 30 wt. % of the rubber modifier, specifically about 88 wt. % to about 94 wt. % of the poly(alkenyl aromatic) resin and about 6 wt. % to about 12 wt. % of the rubber modifier.

Specific rubber-modified poly(alkenyl aromatic) resins include the styrene-butadiene copolymers containing about 88 wt. % to about 94 wt. % styrene and about 6 wt. % to about 12 wt. % butadiene. These styrene-butadiene copolymers, also known as high-impact polystyrenes (HIPS), are commercially available as, for example, GEH 1897 from General Electric Company, and BA 5350 from Chevron Chemical Company.

The rubber-modified poly(alkenyl aromatic) is generally used in amounts of about 10 wt. % to about 70 wt. %. Within this range, the rubber-modified poly(alkenyl aromatic) can be greater than or equal to about 20 wt. %, and more specifically greater than or equal to about 30 wt. %. Also within this range, the rubber-modified poly(alkenyl aromatic) is less than or equal to about 65 wt. %, and more specifically less than or equal to about 60 wt. %. Weight percents are based on a total weight of the composition.

In one embodiment, the poly(arylene ether) is present in an amount of about 20 weight percent to about 80 weight percent; the poly(alkenyl aromatic) is present in an amount of about 5 weight percent to about 20 weight percent; and the rubber-modified poly(alkenyl aromatic) is present in an amount of about 10 to about 70 weight percent; wherein weight percents are based on a total weight of the composition.

The composition may also comprise at least one flame retardant, generally a halogenated material, an organic phosphate, or a combination of the two.

In one embodiment, the composition comprises the organic phosphate flame retardant, wherein the organic phosphate is an aromatic phosphate compound of the formula (III): 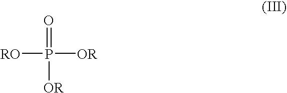
where R is the same or different and is alkyl, cycloalkyl, aryl, alkyl substituted aryl, halogen substituted aryl, aryl substituted alkyl, halogen, or a combination of any of the foregoing, provided at least one R is aryl.

Examples include phenyl bis(dodecyl) phosphate, phenyl bis(neopentyl) phosphate, phenyl bis(3,5,5-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tris(nonylphenyl) phosphate, bis(dodecyl) p-tolyl phosphate, tricresyl phosphate, triphenyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like, and combinations thereof. In one embodiment, the phosphate is one in which each R is aryl or alkyl-substituted aryl.

Alternatively, the organic phosphate can be a di- or polyfunctional compound or polymer having the formula (IV), (V), or (VI) below: 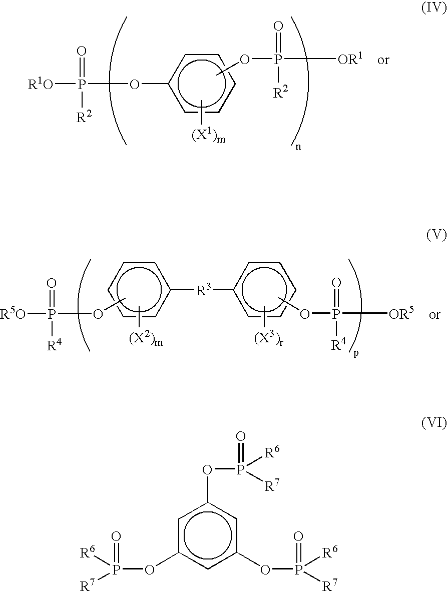
including mixtures thereof, in which R¹, R³, and R⁵ are, independently, hydrocarbon; R², R⁴, R⁶, and R⁷ are, independently, hydrocarbon or hydrocarbonoxy; X¹, X², and X³ are halogen; m and r are, independently, 0, 1, 2, 3, or 4; and n and p are, independently, integers from 1 to about 30.

Examples include the bis diphenyl phosphates of resorcinol, hydroquinone and bisphenol-A, respectively, and their polymeric counterparts.

Methods for the preparation of the aforementioned di- and polyfunctional aromatic phosphates are described in British Patent No. 2,043,083.

Another group of useful flame retardants include certain cyclic phosphates, for example, diphenyl pentaerythritol diphosphate, as a flame retardant agent for poly(arylene ether) resins, as is described by Axelrod in U.S. Pat. No. 4,154,775.

Particularly useful organic phosphates include phosphates containing substituted phenyl groups, phosphates based upon resorcinol such as, for example, resorcinol tetraphenyl diphosphate, as well as those based upon bis-phenols such as, for example, bis-phenol A tetraphenyl diphosphate. In one embodiment, the organic phosphate is selected from the group consisting of butylated triphenyl phosphate, resorcinol diphosphate, bis-phenol A diphosphate, triphenyl phosphate, isopropylated triphenyl phosphate and mixtures of two or more of the foregoing.

In various embodiments, the composition can also include effective amounts of at least one additive such as anti-oxidants, drip retardants, dyes, pigments, colorants, stabilizers, small particle mineral fillers such as clay, mica, and talc, antistatic agents, plasticizers, lubricants, glass fibers (long, chopped or milled), and combinations comprising at least one of the foregoing. These additives are known in the art, as are their effective levels and methods of incorporation. Effective amounts of the additives vary widely, but they can be present in a total amount up to about 60% or more by weight, of the total weight of the composition. In general, additives such as anti-oxidants, flame retardants, drip retardants, dyes, pigments, colorants, stabilizers, antistatic agents, plasticizers, lubricants, and the like are present in amounts of about 0.01 wt. % to about 5 wt. % of the total weight of the composition, while small particle mineral fillers and glass fibers comprise about 1 wt. % to about 60 wt. % of the total weight of the composition.

The composition can be prepared by melt mixing or a combination of dry blending and melt mixing. Melt mixing can be performed in single- or twin-screw type extruders or similar mixing devices that can apply a shear to the components.

All of the ingredients may be added initially to the processing system. In some embodiments, the poly(arylene ether) may be precompounded with the compatibilizing agent to form a functionalized poly(arylene ether). The functionalized poly(arylene ether) is then compounded with the other components. In another embodiment the poly(arylene ether), compatibilizing agent, optional additives are compounded to form a first material, and the high flow poly(alkenyl aromatic) and rubber-modified poly(alkenyl aromatic) are then compounded with the first material.

In various other embodiments, when using an extruder, all or part of the high flow poly(alkenyl aromatic) and rubber-modified poly(alkenyl aromatic) may be added after melting the poly(arylene ether), e.g., through a port downstream. While separate extruders may be used in the processing, preparations in a single extruder having multiple feed ports along its length to accommodate the addition of the various components simplifies the process. It is often advantageous to apply a vacuum to the melt through one or more vent ports in the extruder to remove volatile impurities in the composition.

In one embodiment the composition comprises the reaction product of poly(arylene ether); high flow poly(alkenyl aromatic); and rubber-modified poly(alkenyl aromatic). As used herein a reaction product is defined as the product resulting from the reaction of two or more of the foregoing components under the conditions employed to form the composition, for example during melt mixing or high shear mixing.

After the composition is formed it is typically formed into strands, which are cut to form pellets. The strand diameter and the pellet length are typically chosen to prevent or reduce the production of fines (particles that have a volume less than or equal to 50% of the pellet) and for maximum efficiency in subsequent processing such as profile extrusion. An exemplary pellet length is about 1 millimeter (mm) to about 5 mm and an exemplary pellet diameter is about 1 mm to about 5 mm.

The composition may be converted to articles using low shear thermoplastic processes such as film and sheet extrusion, profile extrusion, extrusion molding, compression molding and blow molding. Film and sheet extrusion processes may include and are not limited to melt casting, blown film extrusion and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating.

Oriented films may be prepared through blown film extrusion or by stretching cast or calendared films in the vicinity of the thermal deformation temperature using conventional stretching techniques. For instance, a radial stretching pantograph may be employed for multi-axial simultaneous stretching; an x-y direction stretching pantograph can be used to simultaneously or sequentially stretch in the planar x-y directions. Equipment with sequential uniaxial stretching sections can also be used to achieve uniaxial and biaxial stretching, such as a machine equipped with a section of differential speed rolls for stretching in the machine direction and a tenter frame section for stretching in the transverse direction.

The compositions may be converted to multiwall sheet comprising a first sheet having a first side and a second side, wherein the first sheet comprises a thermoplastic polymer, and wherein the first side of the first sheet is disposed upon a first side of a plurality of ribs; and a second sheet having a first side and a second side, wherein the second sheet comprises a thermoplastic polymer, wherein the first side of the second sheet is disposed upon a second side of the plurality of ribs, and wherein the first side of the plurality of ribs is opposed to the second side of the plurality of ribs.

The films and sheets described above may further be thermoplastically processed into shaped articles via forming and molding processes including, but not limited to, thermoforming, vacuum forming, pressure forming, injection molding and compression molding. Multi-layered shaped articles may also be formed by injection molding a thermoplastic resin onto a single or multi-layer film or sheet substrate as described below:
1. Providing a single or multi-layer thermoplastic substrate having optionally one or more colors on the surface, for instance, using screen printing or a transfer dye.
2. Conforming the substrate to a mold configuration such as by forming and trimming a substrate into a three dimensional shape and fitting the substrate into a mold having a surface which matches the three dimensional shape of the substrate.
3. Injecting a thermoplastic resin into the mold cavity behind the substrate to (i) produce a one-piece permanently bonded three-dimensional product or (ii) transfer a pattern or aesthetic effect from a printed substrate to the injected resin and remove the printed substrate, thus imparting the aesthetic effect to the molded resin.

Those skilled in the art will also appreciate that common curing and surface modification processes including and not limited to heat-setting, texturing, embossing, corona treatment, flame treatment, plasma treatment and vacuum deposition may further be applied to the above articles to alter surface appearances and impart additional functionalities to the articles.

Accordingly, another embodiment relates to articles, sheets and films prepared from the compositions above.

Exemplary articles include all or portions of the following articles: furniture, partitions, containers, vehicle interiors including rail cars, subway cars, busses, trolley cars, airplanes, automobiles, and recreational vehicles, exterior vehicle accessories such as roof rails, appliances, cookware, electronics, analytical equipment, window frames, wire conduit, flooring, infant furniture and equipment, telecommunications equipment, antistatic packaging for electronics equipment and parts, health care articles such as hospital beds and dentist chairs, exercise equipment, motor covers, display covers, business equipment parts and covers, light covers, signage, air handling equipment and covers, automotive underhood parts.

The following non-limiting examples further illustrate the various embodiments described herein.

### EXAMPLES

The examples employed the materials listed in Table 1. The amounts employed in the Examples are in weight percent based on the total weight of the composition, unless otherwise stated.

TABLE 1

| Material | Description/Supplier |
|---|---|
| PPE | Poly(2,6-dimethyl-1,4-phenylene ether) |
| | having an intrinsic viscosity of 0.46 dl/g |
| | as determined in chloroform at 25° C., |
| | which is commercially available from |
| | GE Advanced Materials. |
| High flow HIPS | 7.7 melt flow index, 8.4% rubber, |
| | 876HF from Japan Polystyrene |
| Standard HIPS | 2.7 melt flow index, 10.3% rubber, |
| | HIPS3190 from GE |
| High flow GPPS | 69.4 melt flow index, not commercially |
| | available, sample was provided by |
| | University of Kentucky |
| Flame Retardant | Resorcinol Diphosphate (RDP) from |
| | Supresta |
| SAN encapsulated PTFE | GE Plastics |
| LLDPE | Nova Chemicals Novapol GM-2024A |
| tris(2,4-di- | Ciba Specialty Chemicals |
| t-butylphenyl)phosphate | |
| Tridecylphosphite | Crompton, TDP Weston |
| Zinc Sulfide | Sachtleben, SACHOLITH HD ZNS |
| Magnesium Oxide | Western Reserve, MagChem HAS-10 |
| Zinc Oxide | GH Chemical Company, CR-4 |

Examples 1-4 were made by combining the components in a twin-screw extruder. The extruded material was injected molded into test specimens for physical property testing. The physical properties, units, and their test methods are listed in Table 2. Megapascals are abbreviated as MPa, Joules are abbreviated as J, meters are abbreviated as m, and grams per minute as g/min. The compositions of the Examples and the data are listed in Table 3.

TABLE 2

| Physical Property | Units | Test Method |
|---|---|---|
| Tensile Yield Strength | MPa | ASTM D 638 |
| Tensile Elongation at Break | % | ASTM D 638 |
| Tensile Modulus | MPa | ASTM D 638 |
| ⅛″ Flexural Yield Stress | MPa | ASTM D 790 |
| ⅛″ Flexural Modulus | MPa | ASTM D 790 |
| 23° C. Notched IZOD | J/m | ASTM D 256 |
| ¼″ HDT @ 1.8 MPa | ° C. | ASTM D 648 |
| MI @ 280° C./5 kg | g/min | ASTM D 1238 |

TABLE 3

| | Ex. 1 | Ex. 2 | Ex. 3 | Ex. 4 |
|---|---|---|---|---|
| PPE | 34.25 | 34.25 | 47.63 | 47.63 |
| High flow HIPS | 63.74 | 0 | 33.93 | 0 |
| Standard HIPS | 0 | 47.81 | 0 | 25.45 |
| High flow GPPS | 0 | 15.94 | 0 | 8.48 |
| Flame Retardant | 0 | 0 | 16.39 | 16.39 |
| SAN encapsulated PTFE | 0 | 0 | 0.49 | 0.49 |
| LLDPE | 1.46 | 1.46 | 1.22 | 1.22 |
| tris(2,4-di-t- | 0 | 0 | 0.08 | 0.08 |
| butylphenyl)phosphite | | | | |
| Tridecylphosphite | 0.48 | 0.48 | 0 | 0 |
| Zinc Sulfide | 0.1 | 0.1 | 0.12 | 0.12 |
| Magnesium Oxide | 0 | 0 | 0.12 | 0.12 |
| Zinc Oxide | 0.1 | 0.1 | 0 | 0 |
| Tensile Yield Strength | 53.6 | 51.2 | 65.6 | 64.5 |
| Tensile Elongation at Break | 20.9 | 23.7 | 9.11 | 9.66 |
| Tensile Modulus | 2840 | 2750 | 2620 | 2610 |
| ⅛″ Flexural Yield Stress | 88.4 | 84.4 | 103 | 102 |
| ⅛″ Flexural Modulus | 2600 | 2630 | 2820 | 2850 |
| 23° C. Notched IZOD | 156 | 174 | 177 | 157 |
| ¼″ HDT @ 1.8 MPa | 110 | 111 | 98.1 | 93.4 |
| MI @ 280° C./5 kg | 33.8 | 64.3 | 32.1 | 31.3 |

As can be seen in Table 3, the use of high flow GPPS resulted in a composition having a melt flow index greater than or equal to 31 grams per minute. In Example 2, the melt flow index was 64.3 grams per minute, which was a significant improvement over Example 1 that employed high flow HIPS. In example 1, the melt flow index was 33.8 grams per minute. Moreover, the mechanical properties of the compositions having the high flow GPPS (Ex. 2 and Ex. 4) were substantially equal to or better than the compositions that did not employ the high flow GPPS.

Advantageously, the use of high flow GPPS can reduce or eliminate the use of high flow HIPS used in the composition. Since the cost of high flow GPPS is significantly less than that of standard HIPS and high flow HIPS, a reduction in manufacturing costs can be realized. These cost reductions coupled with the improvement over compositions comprising high flow HIPS represents a significant commercial advantage.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the invention scope thereof. It is, therefore intended that the invention not be limited to the particular embodiment disclosed as the best mode contemplated for carrying out this invention, but that the invention will include all embodiments falling within the scope of appended claims.

What is claimed is:

1. A resin composition comprising:
a poly(arylene ether);
a poly(alkenyl aromatic) having a melt index of about 10 grams per minute to about 250 grams per minute as measured by ASTM D 1238, Procedure B at 200° C. and 5 kilogram load; and
a rubber-modified poly(alkenyl aromatic).

2. The composition of claim 1, wherein the melt index of the poly(alkenyl aromatic) is greater than or equal to about 30 grams per minute.

3. The composition of claim 1, wherein the poly(arylene ether) is present in an amount of about 20 weight percent to about 80 weight percent; the poly(alkenyl aromatic) is present in an amount of about 5 weight percent to about 20 weight percent; and the rubber-modified poly(alkenyl aromatic) is present in an amount of about 10 to about 70 weight percent; wherein weight percents are based on a total weight of the composition.

4. The composition of claim 1, wherein the composition has a composition melt index of about 20 grams per minute to about 200 grams per minute, as measured by ASTM D1238, Procedure B at 280° C. and 5 kilogram load.

5. The composition of claim 4, wherein the composition melt index is greater than or equal to about 30 grams per minute.

6. The composition of claim 1, wherein the poly(arylene ether) has an initial intrinsic viscosity of about 0.3 deciliters per gram to about 0.6 deciliters per gram as measured in chloroform at 25° C.

7. The composition of claim 1, wherein the poly(alkenyl aromatic) is substantially free of mineral oil.

8. The composition of claim 1, wherein the poly(arylene ether) comprises 2,6-dimethyl-1,4-phenylene ether units.

9. The composition of claim 1, wherein the composition further comprises an organic phosphate flame retardant.

10. The composition of claim 9, wherein the organic phosphate flame retardant comprises resorcinol diphosphate.

11. The composition of claim 1, wherein the rubber-modified poly(alkenyl aromatic) comprises a styrene-butadiene graft copolymer comprising about 88 weight percent to 94 weight percent polystyrene and about 6 to 12 weight percent polybutadiene.

12. An article comprising the composition of claim 1.

13. A resin composition comprising:
a poly(arylene ether) comprising an initial intrinsic viscosity of about 0.3 to about 0.6 deciliters per gram as measured in chloroform at 25° C.;
a poly(alkenyl aromatic) having a melt index of about 10 grams per minute to about 250 gram per minute as measured by ASTM D1238, Procedure B at 200° C. and 5 kilogram load; and
a rubber-modified poly(alkenyl aromatic) comprising a styrene-butadiene graft copolymer comprising about 88 weight percent to about 94 weight percent polystyrene and about 6 weight percent to about 12 weight percent polybutadiene, based on a total weight of the rubber-modified poly(alkenyl aromatic).

14. The composition of claim 13, wherein the melt index is greater than or equal to about 30 grams per minute.

15. The composition of claim 13, wherein the poly(arylene ether) is present in an amount of about 20 weight percent to about 80 weight percent; the poly(alkenyl aromatic) is present in an amount of about 5 weight percent to about 20 weight percent, and the rubber-modified poly(alkenyl aromatic) is present in an amount of about 10 weight percent to about 70 weight percent, wherein weight percents are based on a total weight of the composition.

16. The composition of claim 13, wherein the composition has a composition melt index of about 20 grams per minute to about 200 grams per minute, as measured by ASTM D1238, Procedure B at 280° C. and 5 kilogram load.

17. The composition of claim 16, wherein the composition melt index is greater than or equal to about 30 grams per minute.

18. A method of making a resin composition comprising:
melt mixing a poly(arylene ether) to form a first melt; and
melt mixing
a poly(alkenyl aromatic) having a melt index of about 10 grams per minute to about 250 grams per minute as measured by ASTM D 1238, Procedure B at 200° C. and 5 kilogram load, and
a rubber-modified poly(alkenyl aromatic)
with the first melt.

19. The method of claim 18, wherein the melt index of the poly(alkenyl aromatic) is greater than or equal to about 30 grams per minute.

20. The method of claim 18, wherein the poly(alkenyl aromatic) is substantially free of mineral oil.
